(19) United States
(12) Patent Application Publication
(10) Pub. No.: US 2005/0129396 A1
(43) Pub. Date: Jun. 16, 2005

(54) Camera and a system and method for promoting consumer loyalty

(76) Inventor: Chi Wai Shum, Shatin (CN)

Correspondence Address: CONCORD CAMERA CORP., 4000 HOLLYWOOD BLVD, #650N, HOLLYWOOD, FL, 33021, US

(21) Appl. No.: 10/991,021

(22) Filed: Nov. 17, 2004

Related U.S. Application Data
(60) Provisional application No. 60/525,041, filed on Nov. 25, 2003.

(51) Int. Cl. G03B 17/02

(52) U.S. Cl. 396/536

(57) ABSTRACT

A camera and method for promoting consumer loyalty for film developing services is provided. A camera is provided wherein a particular tool is required to open the film door latch. In one embodiment, a tool is used to bias a door latch finger out of the door latch catch hole and to slide the latch plate. In one particular embodiment, the tool is used by someone other than the consumer when the camera is returned by a consumer to an affiliated outlet. The camera is unlatched, unloaded, reloaded with unexposed film and returned to the consumer.

### PRIORITY

The present application claims priority from co-pending provisional patent application Ser. No. 60/525,041, filed on Nov. 25, 2003, and entitled CAMERA AND A SYSTEM AND METHOD FOR PROMOTING CONSUMER LOYALTY

### FIELD OF THE INVENTION

The present invention relates to the field of cameras and, more particularly, to a camera including a latching mechanism that promotes consumer loyalty in the choice of film developing services.

### BACKGROUND OF THE INVENTION

Many systems have been developed for encouraging consumers to return to a particular establishment for film developing services. In the past, such loyalty programs have provided free film replacement in exchange for developing the film in a certain establishment. The free film was then loaded by the user into the user's own camera of choice.

Other loyalty programs have involved cameras specifically dedicated to a specific loyalty program or rental service.

The Forever Camera Co. of Boca Raton, Fla. announced a reloadable, reusable 35 mm camera that comes pre-loaded with film and a battery. When a customer purchases the camera from a “forever camera” retailer, the purchaser automatically becomes a member of the Forever Camera Club. As a member, the customer qualifies for free film and batteries whenever they bring the camera back to the lab with film for processing. Although offering an incentive to the consumer to return to a Forever Camera Club location for developing, the Forever Camera does not discourage in any way reloading of the film by the consumer, or the taking of the film to another retailer for developing. The Forever Camera is nothing more than a regularly configured 35 mm camera.

U.S. Pat. No. 5,708,856 to Cloutier and U.S. Pat. No. 5,752,085 to Cloutier et al. and assigned to Eastman Kodak Company, relate to a rental camera with a locking device to deter customer reuse after completed exposure. The '085 Cloutier et al. patent discloses a rental camera including a locking device with a key and keyhole arrangement. The Cloutier '856 patent includes a locking screw arrangement. Both Cloutier patents disclose rental cameras which are to be used by a customer for picture-taking and returned to a lender to unlock the film door and unload exposed film and replace with fresh film. A motor within the cameras of the '085 and '856 patents is used to rewind the exposed film into a cartridge.

Two loyalty cameras and systems having the film pre-wound in the camera under non-darkroom conditions have been offered by the present assignee. A first loyalty camera system is shown in commonly assigned U.S. Pat. No. 6,325,555, that patent incorporated herein by reference. Another loyalty camera is shown in commonly assigned U.S. Pat. No. 6,490,411, that patent additionally incorporated herein by reference.

Another loyalty camera and system of the present assignee, is shown in commonly assigned United States Patent Publication No. 2003/0161618, which will issue on Dec. 2, 2003 as U.S. Pat. No. 6,658,206, that patent/publication being incorporated herein by reference.

What is needed is an inexpensive loyalty camera and system wherein a particular mechanism is used by a camera store affiliate to remove exposed film from the loyalty camera. What is further needed is an inexpensive camera and system for promoting user loyalty. These objects, as well as others, are satisfied by the present inventions.

### SUMMARY OF THE INVENTION

A camera and method for promoting consumer loyalty for film developing services is provided. A camera is provided wherein a particular tool is required to open the film door latch. In one embodiment, a tool is used to bias a door latch finger out of the door latch catch hole and to slide the latch plate. In one particular embodiment, the tool is used by someone other than the consumer when the camera is returned by a consumer to an affiliated outlet. The camera is unlatched, unloaded, reloaded with unexposed film and returned to the consumer.

Other objects and advantages of the present invention will become more readily apparent in the description that follows.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred, it being understood however, that the invention is not limited to the specific methods and instrumentality's disclosed. Additionally, like reference numerals represent like items throughout the drawings. In the drawings:

FIG. 1A is a front planar view of a camera.

FIG. 1B is a rear planar view of a camera in accordance with one embodiment of the present invention.

FIG. 2 is a rear view of the camera of one particular embodiment of the present invention, having the latching mechanism cover removed.

FIG. 3 is an enlarged view of a portion of the latching mechanism of the camera of FIG. 2.

FIG. 4 is an enlarged view of a portion of the latching mechanism of the camera of FIG. 2, wherein the latch mechanism has been unlatched.

FIG. 5A is a top enlarged plan view of a tool for use with one embodiment of the present invention.

FIG. 5B is a side enlarged plan view of the tool of FIG. 5A.

FIG. 5C is a bottom enlarged plan view of the tool of FIG. 5A.

FIG. 5D is an enlarged front end view of the tool of FIG. 5A.

FIG. 6 is a flow diagram of one preferred embodiment of a loyalty method useful with the camera of the present invention.

### DETAILED DESCRIPTION OF THE PREFERRED EMBODIMENTS

Before explaining the disclosed embodiments of the present invention in detail, it is to be understood that the invention is not limited in its application to the details of the particular arrangement shown since the invention is capable of other embodiments. Also, the terminology used herein is for the purpose of description and not of limitation.

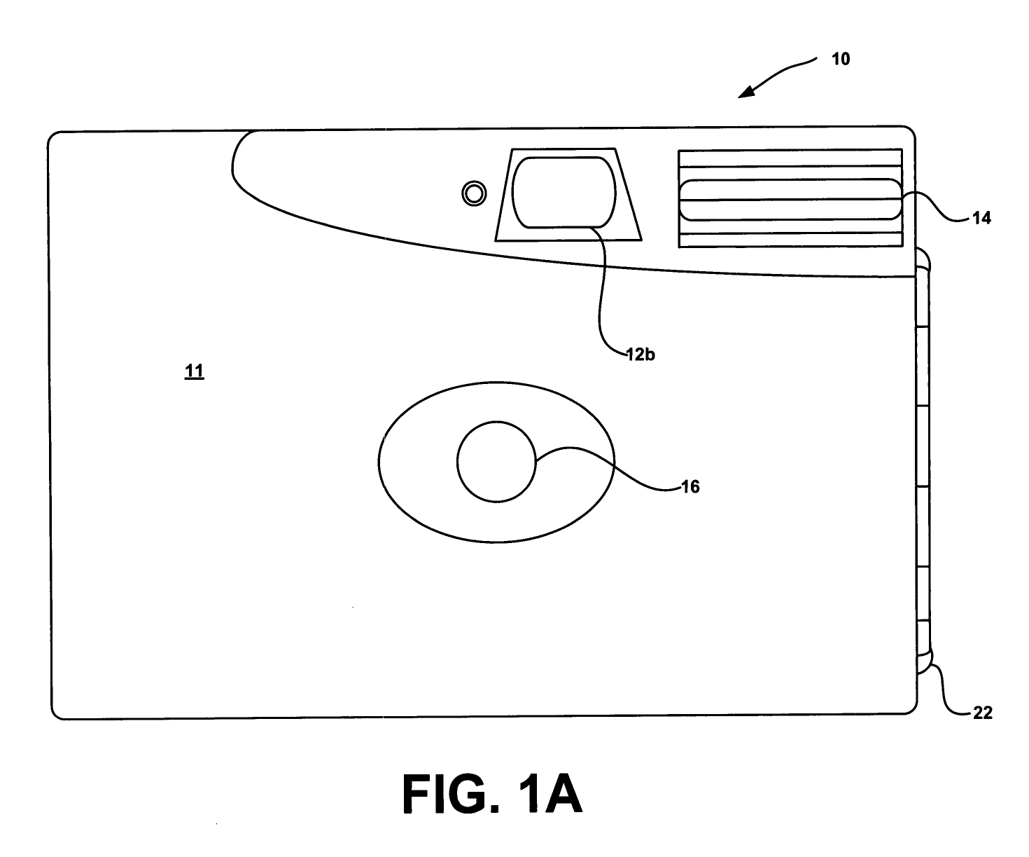

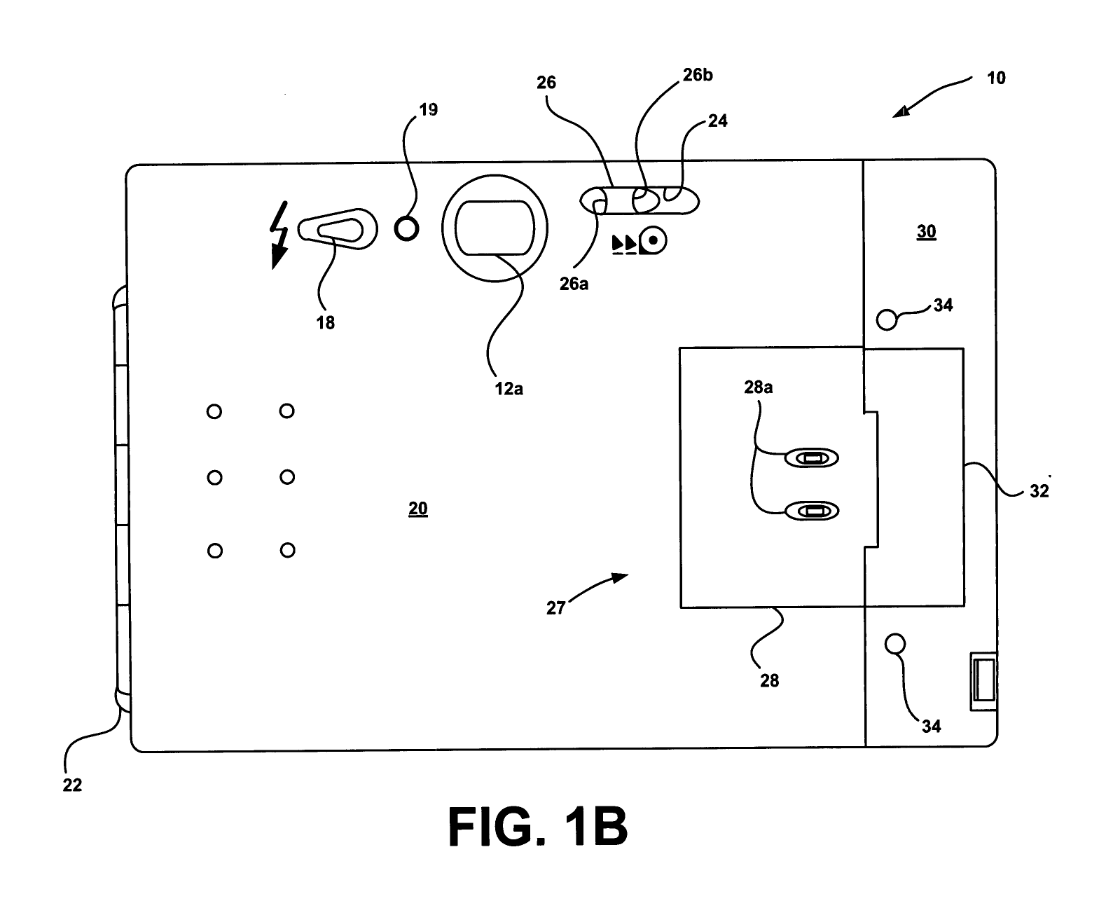

Referring to FIGS. 1-4, the present invention is directed towards a new and improved camera 10 having means for restricting rewinding of the exposed film and for limiting removal and replacement of the film cartridge to those in possession of the particular tool used for these purposes. The camera 10 may be a reusable camera that accepts APS film, 35 mm film, or other film formats.

The camera 10 includes a front cover 11, including an opening for the front viewfinder lens 12b, an opening for the flash lens 14, and an aperture for the taking lens 16, therethrough. Additionally, the camera 10 includes a rear cover, a portion of which is hingedly connected to the front cover 11, by the hinge 22, a flash charging button 18 and a flash ready light 19, such as an LED. Alternatively, the rear cover may be hingedly connected to a portion of the camera body, not shown. Front cover 11 and rear cover 20 are structured to mate with the main body to form a light-tight casing.

It is envisioned in the present embodiment, that the film advance/rewind mechanism is motorized, as is known in the art. A rewind switch slot 24 passes through the rear cover 20. A rewind switch 26 is used to activate the rewind mechanism. In another embodiment, a manual film rewind mechanism, such as that described in commonly assigned, co-pending U.S. patent application Ser. No. 10/613,181, entitled Loyalty Camera and a System and Method for Promoting Consumer Loyalty, may be used, that patent application being incorporated herein by reference.

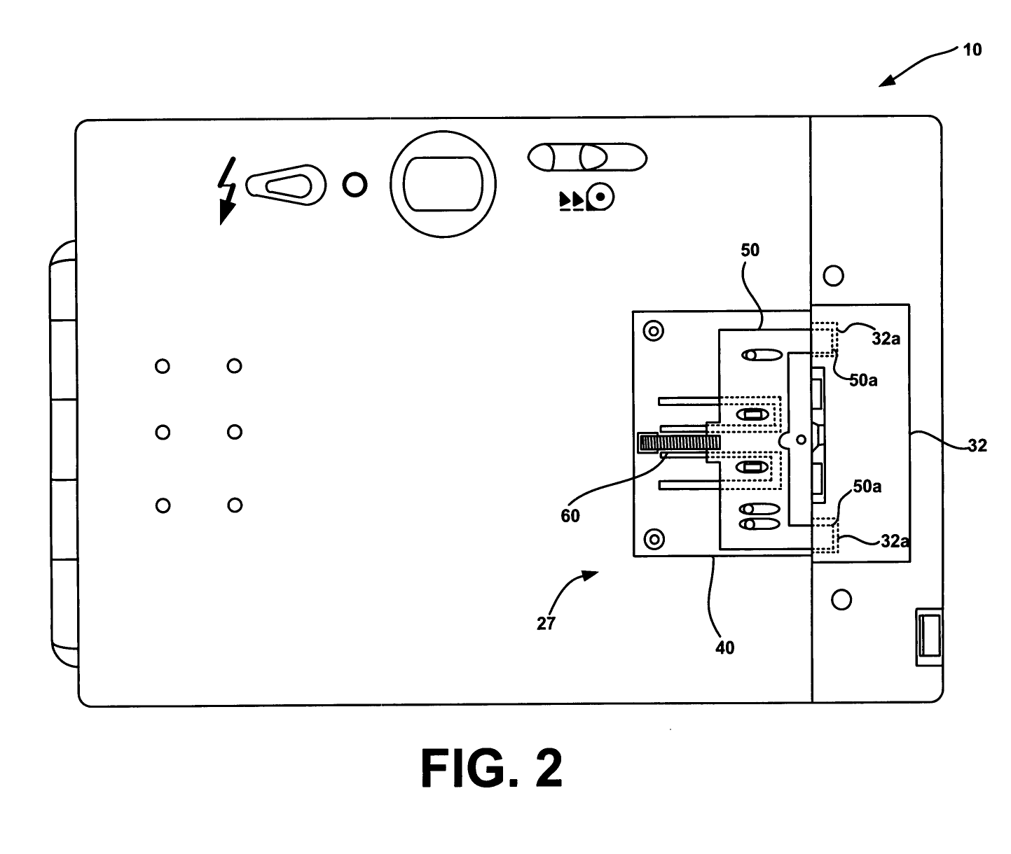

The rear cover of camera 10 comprises a film door 20 and a fixed portion 30. The fixed portion 30 is fixed to the camera body by the screws 34. The film door 20 is movably connected to the front cover 11 by the hinge 22. A latching member 27 secures the film door 20 closed in a light tight arrangement. When latched closed, the film door latch 27 mates with a fixed sill portion 32 on the fixed portion 30 to keep the film door closed. Unlatched, the film door 20 can swing open on the hinge 22 to provide access to a film cartridge receiving compartment (not shown) within the camera 10. The latch mechanism 27 is contained within a cover 28, which is fixed to the camera 10. Access holes 28a provide limited access to the latch mechanism. Only a person with the proper tool to access the latch mechanism 27 through the holes 28a is able to open the film door 20. Note that although two holes 28a are shown, a greater number or fewer number of holes, may be provided as needed. The cover 28 may be snapped into place using holes (46 of FIGS. 2-4) on a mating structure underlying the cover 28.

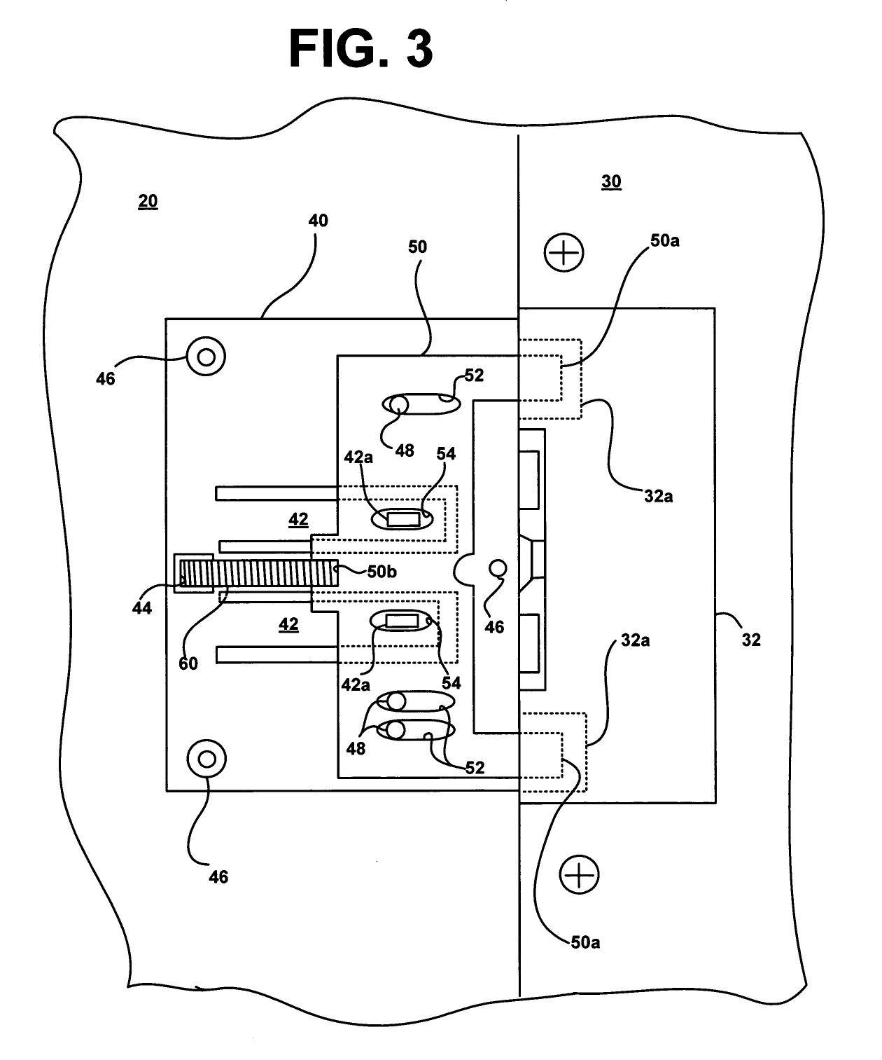

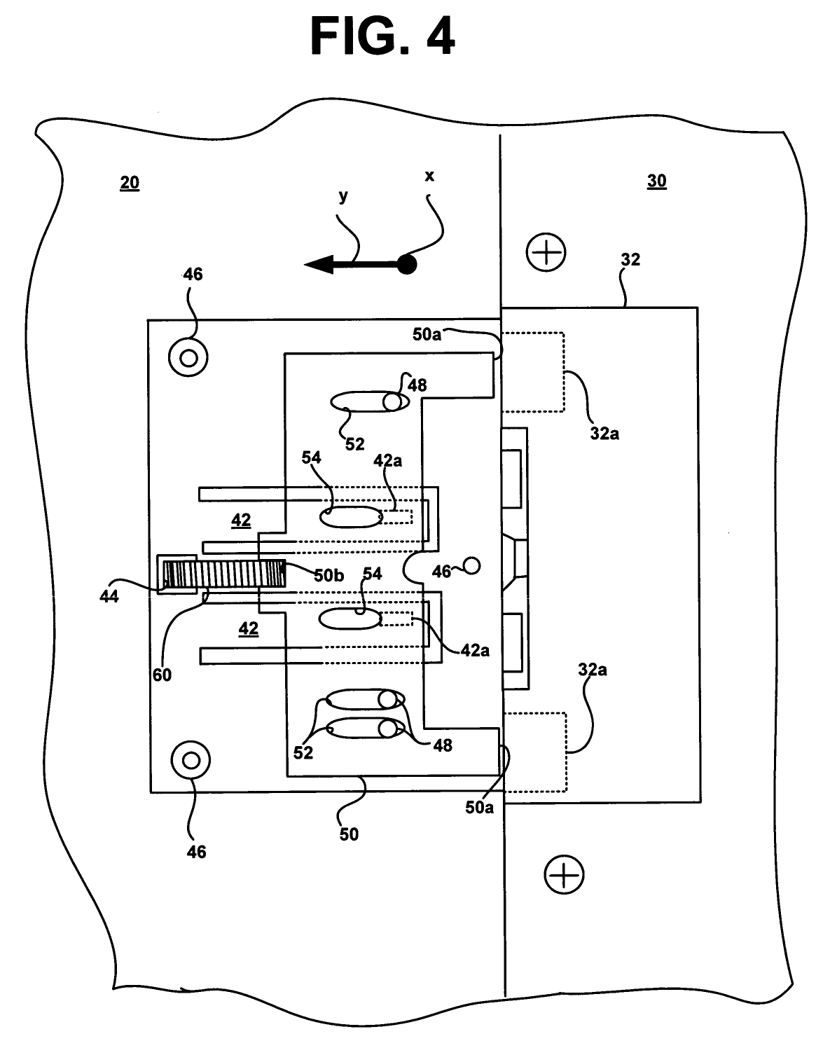

Referring now to FIG. 2, there is shown the camera 10 of FIG. 1B with the cover 28 removed to better shown the latch mechanism 27. FIG. 3 is a partial enlarged view of the latch mechanism 27 of FIG. 2, shown in the latched position. FIG. 4 is a partial enlarged view of the latch mechanism 27 of FIG. 2, with the latch mechanism 27 having been moved by a tool (not shown) into the unlatched state.

The latch mechanism 27 comprises a latch plate 40 that is fixed to the film door 20. In one embodiment, a portion of the latch plate 40 passes through the film door 20 and is heat staked to a plate (not shown) in contact with the interior surface of the film door 20, to better stabilize the latch mechanism 27. The latch plate 40 includes the flexible spring fingers 42. Towards the free end of each spring finger 42 is a projection 42a. The plate 40 is made from a material that permits the spring fingers 42 to flex away from the plane of the latch plate 40 when a pressure is applied to the free ends of the flexible fingers 42. Both to add in the flexibility of the spring fingers 42 and to ensure a space into which the spring fingers can be biased, the spring fingers have a reduced thickness in comparison to the rest of the latch plate 40. Also, if desired, the curvature of the film door 20, can provide an additional space between the latch plate 40 and the surface of the film door 20 into which the spring fingers 42 can be moved. Note that although two spring fingers 42 are shown, it can be seen from the teachings herein that a fewer number or greater number of spring fingers may be used.

The latch plate 40 supports a sliding lock plate 50 parallel thereto, which is used to latch and unlatch the latch mechanism 27. Posts 48 extend up from the surface of the latch plate 40 and through the slots 52 of the sliding lock plate 50 to hold the sliding lock plate 50 to the latch plate 40, and permit the sliding lock plate 50 to slide over the latch plate 40. In one particular embodiment shown, one end of the sliding lock plate 50 includes one slot 52 which mates with one post 48, while the other end includes two slots 52 which mate with two posts 48, to ensure that the sliding lock plate 50 is assembled on the latch plate 40 in the correct orientation.

The amount of travel undergone by the sliding lock plate 50 is limited by the length of the slots 52. Slots 52 should be sized and located to permit the fingers 50a of the sliding lock plate 50 to be free from apertures 32a in the sill 32 (as shown in FIG. 4) to allow the film door 20 to open.

Latch plate 40 additionally includes a channel 44, which is used to capture one end of the compression spring 60 when the latch mechanism 27 is assembled. If desired, a portion of the latch plate 40 near the channel 44 may be curved to complement the curvature of the coil spring 60, so as to better support the spring 60 in the plane of the latch plate 40. Correspondingly, the sliding lock plate 50 also includes a channel 50b, which is used to capture the second end of the compression spring 60. Compression spring 60 provides a spring force between the end walls of the channels 44, 50b, to bias the sliding lock plate 50 into its normally latched position (shown in FIG. 3). In the normally latched position, the fingers 50a engage openings 32a in the sill 32 so that the film door 20 cannot be opened. Additionally, the projections 42a on the spring fingers 42 are captured in catch holes 54 on the sliding lock plate 50, to prevent the sliding lock plate 50 from unintentionally drifting out of the latched position.

Referring now specifically to FIG. 4, there is shown the latching mechanism 27 in the unlatched position. A tool (not shown in FIG. 4) including prongs matched up with catch holes 54 is inserted into the catch holes 54 in the direction of the x-axis, which is perpendicular to and extends into the plane of the page. The prongs of the tool flex the spring fingers 42 away from the sliding lock plate 50 and bias the projections 42a out of the catch holes 54. Simultaneously, the tool is moved linearly in the direction of the length of the camera, along the y-axis, to slide the catch holes 54 away from the projections 42a and to free the locking fingers 50a from the sill apertures 32a. Thus the latch mechanism 27 is unlatched and the film door 20 may be swung open with the tool or the hand of the user. Once the tool is removed from the catch holes 54, the spring 60 biases the sliding lock plate 50 back to the normally biased position, the spring fingers 42 additionally return to their normal positions and the projections 42a are again trapped in the catch holes 54.

With the film door 20 open, the film may be removed and replaced with an unexposed roll of film. To close the film door the tool is used to bias the fingers down (along the x-axis) and slide the lock plate 50 (along the y-axis) to again unlatch the latching mechanism, as described, and the door is closed. When the tool is again removed, the latch is biased by the spring 60 into the latched position.

Referring now to FIGS. 1A-5D, a tool 70 is shown which may be used in connection with the camera 10 of the present inventions. The tool 70 includes a pair of pins 72, sized to engage holes 28a, 54, to permit the door latch mechanism 27 to be unlatched and to open the film door 20. Indicia may be provided on the top face of the tool 70 to instruct the user of its proper usage to open the film door 20. Additionally, the central portion 74 may be formed to allow the user to better grasp the tool 70 during use.

A pin 76 including a tip 78 extends from one end of the tool 70. If desired, the tip 78 may be used to rewind/prewind the film in the motorized embodiment of the camera 10. For example, to prevent the user from prematurely rewinding the film, the rewind switch (26 if FIG. 1B) may be made flush with the film door 20. Notches 26a and 26b may be sized to receive the tip 78. Manipulation of the tool 70, while the tip 78 is engaged with one of the notches 261, 26b will slide the switch 26 from one end to the other of the switch slot 24 and activate the film rewind mechanism. When the film is rewinded, the tool 70 may be used to return the switch 26 to its normal position, to ready the camera for a subsequent use. As such, in the particular embodiment described, it can be seen that the tool 70 is necessary to rewind the exposed film. If the camera 10 were one in which film were pre-wound, the tool 70 could be used to activate the motor to prewind the film.

Additionally, the tool 70 may be used in connection with an embodiment of the camera 10 wherein the film is manually rewound/prewound. For example, in co-pending commonly assigned U.S. patent application Ser. No. 10/613,181, that application incorporated herein by reference, a manually rewound camera is disclosed. That camera includes an end cap disposed over the film advance wheel. The tool 70 may, optionally, include a generally circular-shaped area 75, having at least one outwardly extending pin 75a, extending out from its bottom face. In one particular embodiment, four pins 75a extend perpendicularly from the bottom face. Note however that the number of pins 75a used is merely a design choice. The prongs 75a are structured and disposed to mate with corresponding holes in the upper end cap of the camera, which are connected by a stem to the film advance wheel of the camera. Generally circular shaped area 75 and pins 75a are arranged to engage the upper end cap.

In such an embodiment, the post 76 of the tool 70 would act as a handle extending out from its top face, in generally perpendicular relation thereto, to facilitate grasping and rotation of the tool 70 during manual film rewinding.

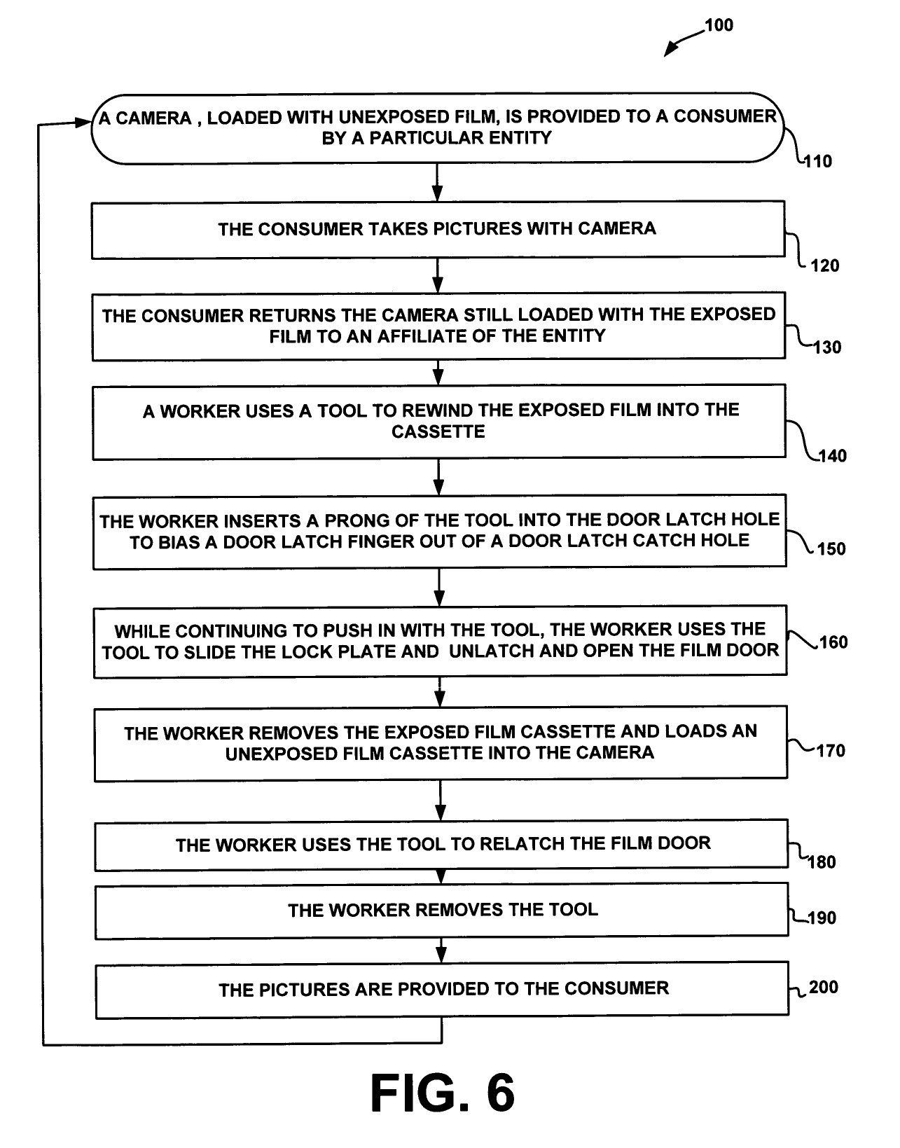

One particular embodiment of a loyalty method using the camera 10 of FIGS. 1-4, will now be described in connection with FIG. 6. Referring now to FIG. 6, there is shown a flow diagram of a camera loyalty system 100.

A camera, loaded with unexposed film, is provided to a consumer by a particular entity. Step 110. The entity providing the camera may be a retail store or outlet, or an internet or other entity. The present loyalty system is provided so as to motivate the consumer, once the film has been exposed, to return the film to an affiliate of the entity (i.e. another location of the original entity an entity in business with or affiliated with the original entity and/or the original entity, itself) for film developing. As such, the camera may be purchased by the consumer from the entity, or the camera may be provided free of charge to the consumer as part of a promotional incentive by the entity.

The consumer than takes pictures with the camera on the film provided. Step 120. The consumer is not provided with the tool necessary for opening the camera and/or rewinding the film, so the camera, loaded now with the exposed film, must be returned for developing to an affiliate of the original entity that has the necessary tool. Step 130. This may be done by walking into an affiliate of the entity and handing a worker the camera, or by returning the camera by mail, in the case of an internet entity.

In one particular embodiment, a worker (not the consumer) affiliated with the entity uses the tool to rewind the exposed film into the original film cassette. Step 140. As described above, if the camera is motorized, a tip of the tool may be used to activate the rewind motor switch. If the camera is manually rewound, a mating portion of the tool may be used to rewind the film. Note that if the camera is of the “pre-wind” variety, this step 140 may be omitted and a corresponding step for “pre-winding” the film would be provided after step 190 of the method 100.

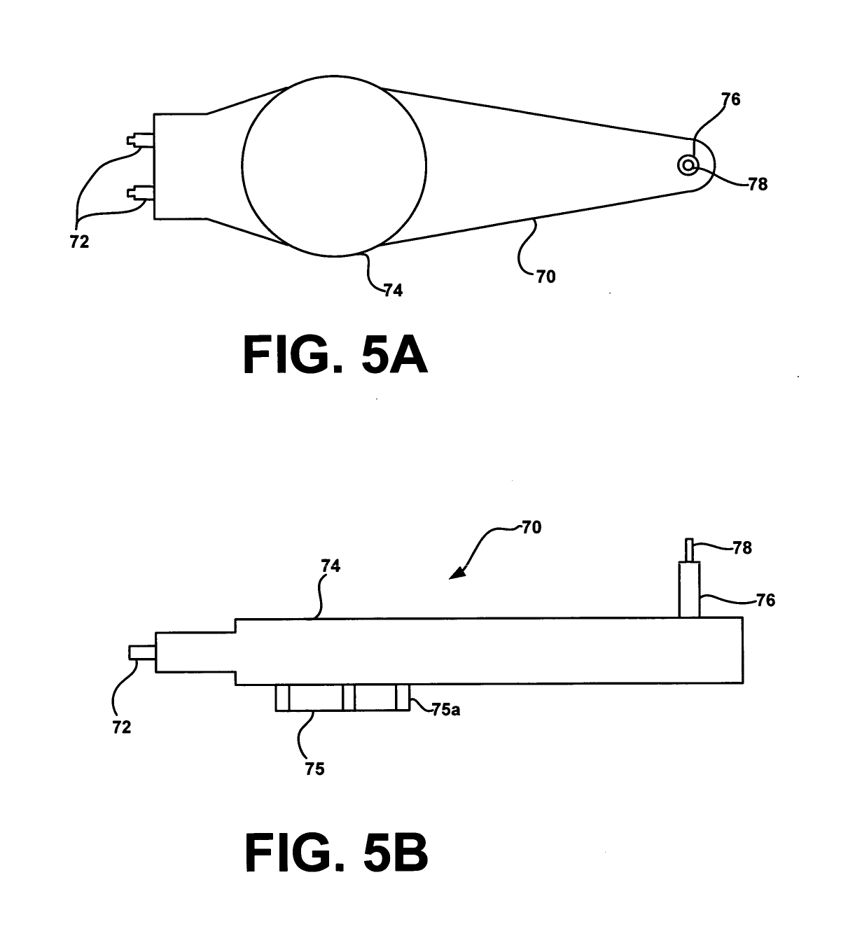

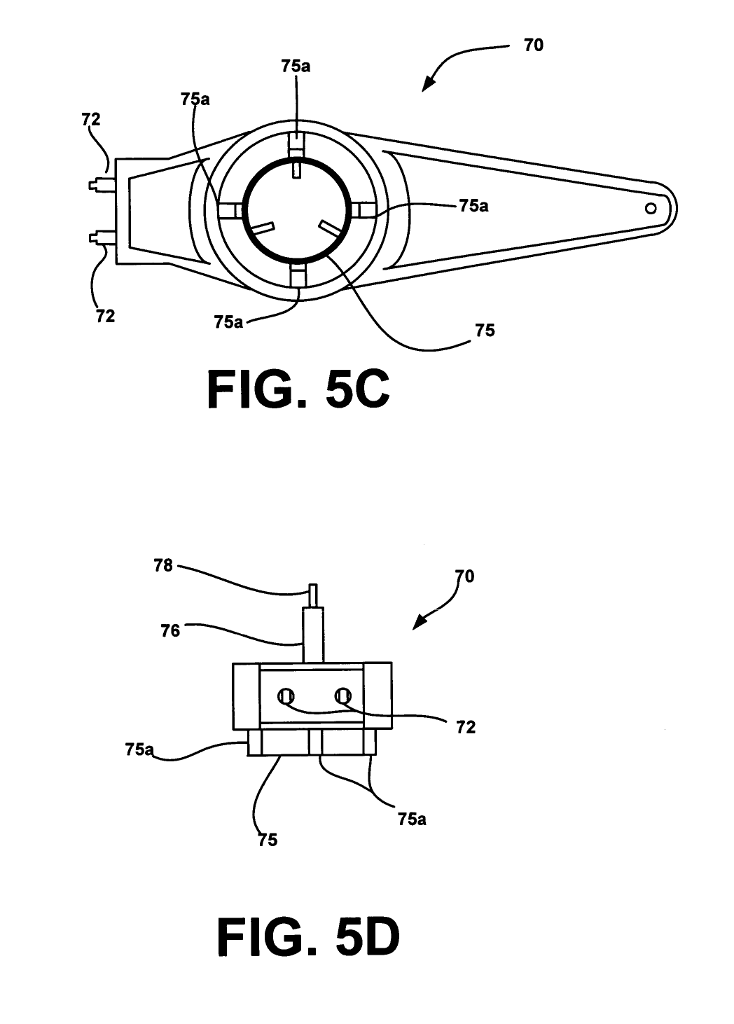

To open the camera and take out the exposed film cassette, the worker inserts a prong (72 of FIG. 5A) into the door latch hole and presses down (in the direction of the x-axis of FIG. 4) to bias the spring fingers out of locking engagement with the catch holes. Step 150. With the tool inserted through the catch holes, the worker uses the tool to slide the lock plate (in the direction of the y-axis of FIG. 4) to unlatch and open the film door. Step 160.

The worker then removes the cassette containing the exposed film, and loads an unexposed film cassette into the camera. Step 170. Using the tool as described above, the worker relatches the camera film door. Step 180. In one motorized embodiment of the invention, closing the film door automatically loads the film to the ready position.

Step 180, the worker removes the tool from the door latch mechanism. Step 190. The film is developed and the pictures are provided by the affiliate to the consumer in a desired format (i.e. prints, photoCD, email, etc.). Step 200. Additionally, the camera, again loaded with unexposed film, is provided back to the consumer. Step 110. The need for the tool to recover the exposed film ensures that the consumer will return the exposed film, still intact in the camera, to a desired affiliated entity.

As further incentive to return the camera to the affiliated entity, in one embodiment of the loyalty program described herein, the new roll of film is provided to the consumer free of charge. The consumer is charged only for the developed prints and (if desired) the initial purchase of the camera.

While the invention has been described with reference to certain embodiments, it will be understood by those skilled in the art that various changes may be made and equivalents may be substituted for elements thereof without departing from the scope of the invention. Although the present loyalty camera is described as using a tool to operate both the rewind mechanism and the door lever, it can be seen that the present loyalty system may be implemented wherein the particular tool is used to operate only one of the rewind mechanism and the door lever, permitting the consumer to freely operate the other of the rewind mechanism and the door lever. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A camera, comprising:
a film door;
a film door latch mechanism fixed to said film door;
a door sill located adjacent said film door;
wherein said film door latch mechanism, comprises,
a latch plate fixed to said film door, said latch plate including at least one spring finger including a protrusion extending therefrom,
a sliding lock plate, a portion of which engages said door sill when said lock plate is in a first position and does not engage said door sill when said lock plate is in a second position, said sliding lock plate being located parallel to and in communication with said latch plate, said sliding lock plate additionally including at least one catch hole, said protrusion being engaged in said at least one catch hole when said lock plate is in said first position, and
a spring connected between said latch plate and said sliding lock plate to normally bias said sliding lock plate into said first position.

2. The camera of claim 1, further comprising an externally applied tool for moving said sliding lock plate from said first position to said second position.

3. The loyalty camera system of claim 2, wherein said tool includes at least one prong sized to engage said at least one catch hole and disengage said at least one protrusion to permit said sliding lock plate to slide.

4. A method of using a loyalty camera system, comprising the steps of:
providing a loyalty camera to a consumer, wherein said loyalty camera comprises:
a film door;
a film door latch mechanism fixed to said film door;
a door sill located adjacent said film door;
wherein said film door latch, comprises,
a latch plate fixed to said film door, said latch plate including at least one spring finger including a protrusion extending therefrom,
a sliding lock plate, a portion of which engages said door sill when said lock plate is in a first position and does not engage said door sill when said lock plate is in a second position, said sliding lock plate being located parallel to and in communication with said latch plate, said sliding lock plate additionally including at least one catch hole, said protrusion being engaged in said at least one catch hole when said lock plate is in said first position,
a spring connected between said latch plate and said sliding lock plate to normally bias said sliding lock plate into said first position; and
providing a tool to a non-consumer affiliate of the loyalty camera system; said tool including at least one prong sized to engage said at least one catch hole and disengage said at least one protrusion to permit said sliding lock plate to slide;
using said tool to push said protrusion out of said catch hole and simultaneously slide said lock plate linearly along said latch plate into the second position;
replacing a new canister of film into said loyalty camera on behalf of said consumer, wherein said replacing step is performed by said non-consumer affiliate; and
returning said loyalty camera to said consumer after said replacing step.

5. The method of claim 4, wherein said new canister of film is provided with no charge to said consumer.

6. A camera, comprising:
a film door;
a film door latch mechanism fixed to said film door;
a door sill located adjacent said film door;
wherein said film door latch mechanism, comprises,
a latch plate fixed to said film door,
a sliding lock plate, a portion of which engages said door sill when said lock plate is in a first position and does not engage said door sill when said lock plate is in a second position, said sliding lock plate being located parallel to and in communication with said latch plate, said sliding lock plate additionally including at least one catch hole, and
a spring connected between said latch plate and said sliding lock plate to normally bias said sliding lock plate into said first position.

7. The camera of claim 6, further comprising an externally applied tool for moving said sliding lock plate from said first position to said second position.

8. The loyalty camera system of claim 7, wherein said tool includes at least one prong sized to engage said at least one catch hole to permit said sliding lock plate to slide.

9. A method of using a loyalty camera system, comprising the steps of:
providing a loyalty camera to a consumer, wherein said loyalty camera comprises:
a film door;
a film door latch mechanism fixed to said film door;
a door sill located adjacent said film door;
wherein said film door latch mechanism, comprises,
a latch plate fixed to said film door,
a sliding lock plate, a portion of which engages said door sill when said lock plate is in a first position and does not engage said door sill when said lock plate is in a second position, said sliding lock plate being located parallel to and in communication with said latch plate, said sliding lock plate additionally including at least one catch hole,
a spring connected between said latch plate and said sliding lock plate to normally bias said sliding lock plate into said first position; and
providing a tool to a non-consumer affiliate of the loyalty camera system; said tool including at least one prong sized to engage said at least one catch hole to permit said sliding lock plate to slide;
using said tool to slide said lock plate linearly along said latch plate into the second position;
replacing a new canister of film into said loyalty camera on behalf of said consumer, wherein said replacing step is performed by said non-consumer affiliate; and
returning said loyalty camera to said consumer after said replacing step.

10. The method of claim 9, wherein said new canister of film is provided with no charge to said consumer.
